(19) United States
(12) Patent Application Publication
(10) Pub. No.: US 2008/0210779 A1
(43) Pub. Date: Sep. 4, 2008

(54) Auxiliary line-drawing apparatus for a paint-spraying can

(76) Inventor: Hsiu-Man Yu Chen, Taichung (TW)

Correspondence Address: BRUCE H. TROXELL, SUITE 1404, 5205 LEESBURG PIKE, FALLS CHURCH, VA, 22041, US

(21) Appl. No.: 11/712,583

(22) Filed: Mar. 1, 2007

(51) Int. Cl. B05B 15/06

(52) U.S. Cl. 239/280

(57) ABSTRACT

An auxiliary line-drawing apparatus for a paint-spraying can mainly includes a long rod, a pull rod and a cylinder. The pull rod able to be shifted up and down is in parallel assembled with the inner side of the long rod, and has its upper end formed with a pull hook and its lower end formed with a U-shaped press member. A position-limiting member is clasped on the inner side of an intermediate section of the long rod for restricting a paint-spraying can in position. When the paint-spraying can is inversely deposited in the cylinder, the pull rod can be pulled upward by the pull hook to actuate its lower press member to press the spray nozzle of the paint-spraying can to spray paint for drawing lines.

### BACKGROUND OF THE INVENTION

1. Field of the Invention

This invention relates to an auxiliary line-drawing apparatus for a paint-spraying can, particularly to one provided with a long rod and a pull rod. The pull rod able to be shifted up and down has its lower end formed with a press member for pressing the spray nozzle of a paint-spraying can inversely deposited in a cylinder to spray paint for drawing lines.

2. Description of the Prior Art

Conventionally, powdered lime is employed for drawing lines or making marks on the ground, but such lines or marks are easy to become vague after a long period of time, likely to cause an accident in case the lines or the marks are of great importance. To improve the drawback mentioned above, a paint-spraying can is used for drawing lines on the ground, as paint is easy to adhere to the ground and the lines made by paint are able to last long. The conventional paint-spraying can is provided with a spray nozzle to be pressed for spraying paint on any place. However, using the conventional paint-spraying can for drawing lines, a user has to press the spray nozzle incessantly with fingers, and the shapes of lines drawn by spraying paint are always imperfect and additionally such a hand-operated paint-spraying can is likely to soil a user's hands, resulting in much inconvenience in use.

### SUMMARY OF THE INVENTION

The objective of this invention is to offer an auxiliary line-drawing apparatus for a paint-spraying can, which mainly includes a long rod, a pull rod and a cylinder. The long rod has its intermediate portion fastened thereon with a position-limiting member. The pull rod able to be shifted up and down has its upper end formed with a pull hook and its lower end formed integral with a press member. The cylinder is axially assembled at the inner side of the long rod for receiving a paint-spraying can therein. When the paint-spraying can is inversely deposited in the cylinder, the press member of the long rod, which is able to recover its original position after shifted transversely, will guide the paint-spraying can, and hold it in position, and the press member at the lower end of the pull rod will be actuated by the pull hook to press the spray nozzle of the paint-spraying can to spray paint for drawing lines.

### BRIEF DESCRIPTION OF DRAWINGS

This invention will be better understood by referring to the accompanying drawings, wherein:

FIG. 1 is a perspective view of an auxiliary line-drawing apparatus for a paint-spraying can in the present invention;

FIG. 2 is another perspective view of the auxiliary line-drawing apparatus for a paint-spraying can in the present invention;

FIG. 3 is a side cross-sectional view of the auxiliary line-drawing apparatus for a paint-spraying can in the present invention, showing that a paint-spraying can is to be inversely deposited in a cylinder; and

FIG. 4 is a side cross-sectional view of the auxiliary line-drawing apparatus for a paint-spraying can in a using condition in the present invention.

### DETAILED DESCRIPTION OF THE PREFERRED EMBODIMENT

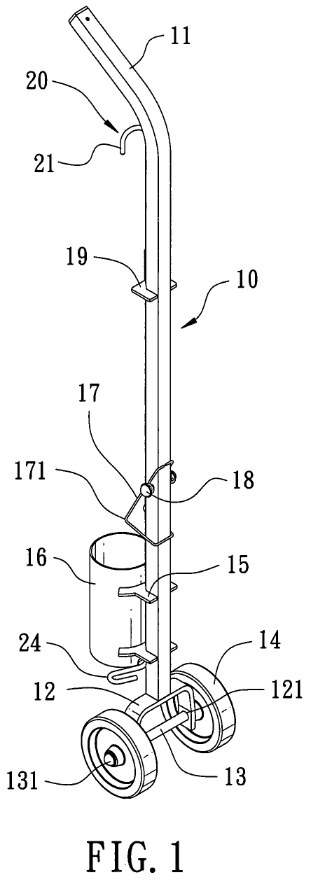

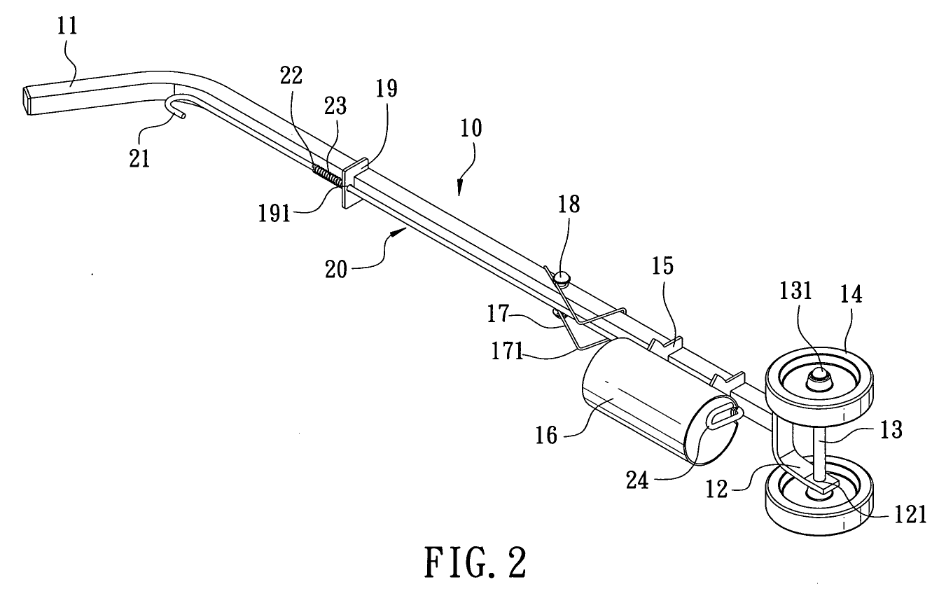

A preferred embodiment of an auxiliary line-drawing apparatus for a paint-spraying can in the present invention, as shown in FIGS. 1, 2 and 3, includes a long, rod 10 and a pull rod 20 as main components combined together.

The long rod 100 has its upper end formed with a grip 11 and its lower end combined with a U-shaped rod 12 having the opposite walls of its opening respectively and symmetrically bored with a round hole 121. A threaded rod 13 is inserted through the opposite round holes 121 and has its opposite ends respectively assembled thereon with a rotating wheel 14 by means of nuts 131. Further, the long rod 10 has its inner side secured thereon with two Y-shaped plates 15 spaced apart properly and positioned above the U-shaped rod 12. A hollow cylinder 16 is fixed on the opening edges of the two Y-shaped plates 15, and a point-spraying can 200 is inversely fitted in the interior of the cylinder 16, having its spray nozzle 201 facing downward. A position-limiting member 17 made of an elastic iron bar bent in shape is fastened on the long rod 10 and positioned above the cylinder 16, having its opposite ends bent upward and respectively wound on two screws 18 locked on the opposite sides of the long rod 10 and its intermediate portion bent along the long rod 10 and formed with a projecting corner 171, which is able to elastically recover its original position after shifted transversely and functions to guide the paint-spraying can 200 to be fitted in the cylinder 16 and also restrict it in position.

The pull rod 20 able to be shifted up and down is composed of a pull hook 21, an elastic member 23 and a U-shaped press member 24. The pull rod 20 is in parallel assembled with the inner side of the long rod 10 and inserted through the round hole 191 of a U-shaped plate 19 and the round holes (not shown) of the two Y-shaped plates 15 on the long rod 10. The pull rod 20 has its upper end bent and formed integral with the pull hook 21 for facilitating pulling the pull rod 20. The elastic member 23 is fitted on the lower end of the pull hook 21, and a projecting block 22 is secured on the lower end of the pull hook 21 and positioned over the elastic member 23 for facilitating the pull hook 21 to press the elastic member 23 for controlling its position, and the U-shaped press member 24 is formed integral at the lower end of the pull rod 20. Thus, after the paint-spraying can 200 is inversely positioned in the cylinder 16 and has its spray nozzle exposed out of the lower side of the cylinder 16 and when the pull hook 21 is pulled upward, the spray nozzle of the paint-spraying can 200 will be pressed by the press member 24 of the pull rod 20 to spray paint for drawing lines.

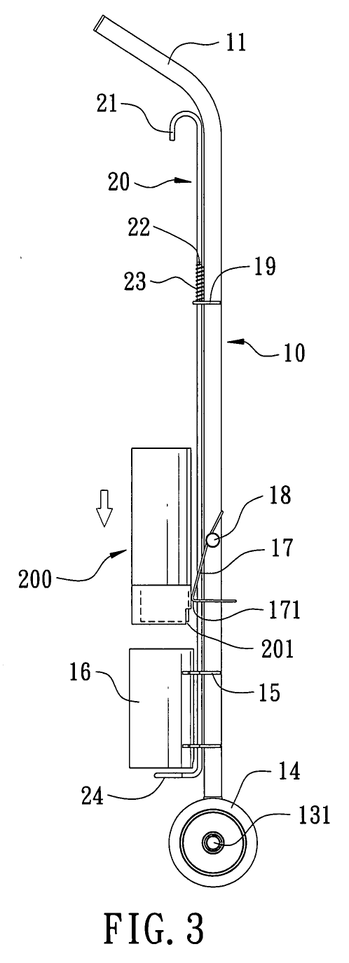

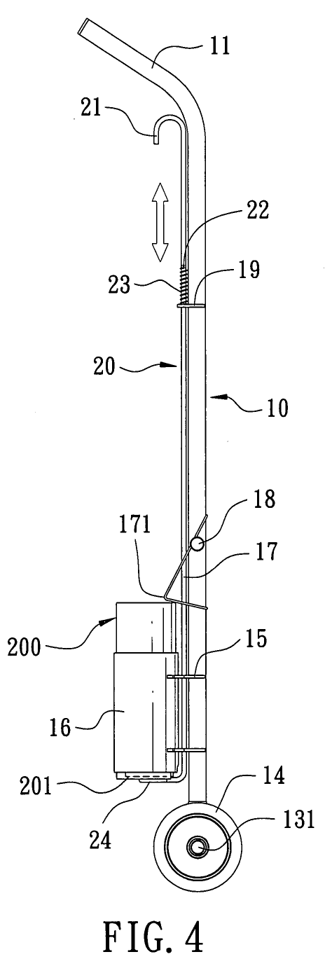

In using, as shown in FIGS. 3 and 4, firstly, inversely deposit the paint-spraying can 200 in the cylinder 16, letting the spray nozzle 201 of the paint-spraying can 200 exposed out of the lower side of the cylinder 16 and the bottom of the paint-spraying can 200 held in position by the position-limiting member 17, and then hold the grip 11 of the long rod 10 to push the line-drawing apparatus forward. To carry out spraying paint and drawing lines, only pull upward the pull hook 21 of the pull rod 20 to actuate the press member 24 at the lower end of the pull rod 20 to compress the spray nozzle 201 of the paint-spraying can 200 to spray paint for drawing lines.

As can be understood from the above description, this invention has the following advantages.

1. The pull rod 20 has its upper end formed with the pull hook 21 for controlling the paint-spraying can 200 to spray paint and draw-lines at the same time when the line-drawing apparatus is pushed forward. And the pull rod 20 has its lower end formed with the U-shaped press member 24 for compress the spray nozzle 201 of the paint-spraying can 200 and restricting the directions of the spray nozzle 201.

2. The long rod has its upper end provided with a grip 11 and its lower end disposed with the two rotating wheels 14 so that the line-drawing apparatus of this invention can be pushed by hands to carry out drawing lines, conforming to ergonomics and avoiding trouble caused by holding a paint-spraying can with hands for drawing lines.

3. The cylinder 16 of the line-drawing apparatus functions to restrict and control the paint-spraying can 200 to be inversely positioned in an accurate direction so as to prevent the paint-spraying can 200 from shifting and causing deviation during drawing lines.

4. The projecting corner 171 of the position-limiting member 17 of the line-drawing apparatus functions to guide the paint-spraying can 200 to be deposited in the cylinder 16, able to automatically recover its original position after shifted transversely and also functions to resist, against the bottom of the paint-spraying can 200 for restricting the paint-spraying can 200 in position.

While the preferred embodiment of the invention has been described above, it will be recognized and understood that various modifications may be made therein and the appended claims are intended to cover all such modifications that may fall within the spirit and scope of the invention.

I claim:

1. An auxiliary line-drawing apparatus for a paint-spraying can comprising:
a long rod having its lower inner side axially fixed with a hollow cylinder at a preset location, said hollow cylinder receiving therein a paint-spraying can, a position-limiting member fastened at the intermediate inner side of said long rod for resisting against the bottom of said paint-spraying can; and
a pull rod assembled in parallel with the inner inside of said long rod, said pull rod able to be shifted up and down along said long rod, said pull rod having its lower end transversely bent and formed with a press member facing the bottom of said cylinder, said press member of said pull rod pushing against the spray nozzle of said paint-spraying can after said paint-spraying can is inversely deposited in said cylinder.

2. The auxiliary line-drawing apparatus for a paint-spraying can as claimed in claim 1, wherein said long rod has its lower end assembled with two rotating wheels for facilitating said auxiliary line-drawing apparatus to move forward and draw lines quickly.

3. The auxiliary line-drawing apparatus for a paint-spraying can as claimed in claim 1, wherein said position-limiting member is an elastic iron bar bent in shape, said position-limiting member having two ends respectively bent upward and wound on two screws that are locked at the opposite sides of said long rod, said position-limiting member having its intermediate portion bent along said long rod and formed with a projecting corner, said projecting corner of said position-limiting member able to elastically recover its original position after shifted transversely, said projecting portion of said position-limiting member guiding and restrictedly positioning said paint-spraying can when said paint-spraying can is inversely received in said cylinder.

4. The auxiliary line-drawing apparatus for a paint-spraying can as claimed in claim 1, wherein said pull rod has its upper end formed integral with a pull hook for the convenience of pulling said pull rod.

5. The auxiliary line-drawing apparatus for a paint-spraying can as claimed in claim 4, wherein an elastic member is fitted on said pull rod, said spray nozzle of said paint-spraying can in said cylinder pressed to spray paint by the pressure of said elastic member and by said press member when said pull hook is pulled upward.

6. The auxiliary line-drawing apparatus for a paint spraying can as claimed in claim 5, wherein said elastic member is a compression spring.

7. The auxiliary line-drawing apparatus for a paint-spraying can as claimed in claim 1, wherein said press member is formed integral by bending the lower end of said pull rod into a U shape for pressing and restrictedly positioning said spray nozzle of said paint-spraying can.
